(19) United States
(12) Patent Application Publication
(10) Pub. No.: US 2024/0062003 A1
(43) Pub. Date: Feb. 22, 2024

(54) MACHINE LEARNING TECHNIQUES FOR GENERATING SEMANTIC TABLE REPRESENTATIONS USING A TOKEN-WISE ENTITY TYPE CLASSIFICATION MECHANISM

(71) Applicant: Optum, Inc., Minnetonka, MN (US)

(72) Inventors: Mrityunjai Singh, Noida (IN); Aviral Sharma, Jaipur (IN); Jatin Lamba, Gola Gokarannath (IN); Shreyansh S. Nanawati, Kalyan(W) (IN); Deeksha Thareja, Delhi (IN); Siddharth Sharma, Gurgaon (IN)

(21) Appl. No.: 17/821,269

(22) Filed: Aug. 22, 2022

(51) Int. Cl. G06F 40/284; G06F 40/30; G06F 40/295; G06V 30/412; G06T 11/20; G06F 16/901

(52) U.S. Cl. CPC G06F 40/284; G06F 40/30; G06F 40/295; G06V 30/412; G06T 11/206; G06F 16/9024

(57) ABSTRACT

Various embodiments of the present invention provide methods, apparatus, systems, computing devices, computing entities, and/or the like for performing natural language processing operations by generating semantic table representations for table data objects using a token-wise entity type classification mechanism whose output space is defined by a set of defined entity types characterized by an inter-related entity type taxonomy to generate a representation of a table data object that describes per-token semantic inferences and cross-token semantic inferences performed on the table data object in accordance with subject-matter-domain insights as described by the inter-related entity type taxonomy.

### BACKGROUND

Various embodiments of the present invention address technical challenges related to performing natural language processing and provide solutions to address the efficiency and reliability shortcomings of existing natural language processing solutions.

### BRIEF SUMMARY

In general, various embodiments of the present invention provide methods, apparatus, systems, computing devices, computing entities, and/or the like for performing natural language processing operations by generating semantic table representations for table data objects using a token-wise entity type classification mechanism whose output space is defined by a set of defined entity types characterized by an inter-related entity type taxonomy to generate a representation of a table data object that describes per-token semantic inferences and cross-token semantic inferences performed on the table data object in accordance with subject-matter-domain insights as described by the inter-related entity type taxonomy.

In accordance with one aspect, a method is provided. In one embodiment, the method comprises: (i) identifying a plurality of table tokens of the table data object, wherein each table token is associated with a relative token position measure within the table data object; (ii) for each table token: (a) generating, using a token-wise entity type classification machine learning model, a predicted entity type, wherein: (1) the predicted entity type is selected from a plurality of defined entity types associated with an inter-related entity type taxonomy for the table data object, and (2) the inter-related entity type taxonomy defines, for each defined entity type, a potentially related defined entity type set of the plurality of defined entity types, and (b) generating a related token set of the plurality of table tokens for the table token, wherein: (1) each related table token in the related token set is associated with a corresponding defined entity type that is in the potentially-related defined entity type set, and (2) each related table token in the related token set is selected based at least in part on the relative token position measure for the table token and the relative token position measure for the related table token; (iii) generating, based at least in part on the plurality of table tokens and each related token set, a graph-based table representation for the table data object, wherein: (a) nodes of the graph-based table representation correspond to the plurality of table tokens, and (b) links of the graph-based table representation correspond to cross-token relationships defined by each related token set; (iv) generating, based at least in part on performing one or more defined-pattern graph traversal operations performed on the graph-based table representation, a semantic table representation; and (v) performing one or more prediction-based actions based at least in part on the semantic table representation.

In accordance with another aspect, an apparatus comprising at least one processor and at least one memory including computer program code is provided. In one embodiment, the at least one memory and the computer program code may be configured to, with the processor, cause the apparatus to: (i) identify a plurality of table tokens of the table data object, wherein each table token is associated with a relative token position measure within the table data object; (ii) for each table token: (a) generate, using a token-wise entity type classification machine learning model, a predicted entity type, wherein: (1) the predicted entity type is selected from a plurality of defined entity types associated with an inter-related entity type taxonomy for the table data object, and (2) the inter-related entity type taxonomy defines, for each defined entity type, a potentially related defined entity type set of the plurality of defined entity types, and (b) generate a related token set of the plurality of table tokens for the table token, wherein: (1) each related table token in the related token set is associated with a corresponding defined entity type that is in the potentially-related defined entity type set, and (2) each related table token in the related token set is selected based at least in part on the relative token position measure for the table token and the relative token position measure for the related table token; (iii) generate, based at least in part on the plurality of table tokens and each related token set, a graph-based table representation for the table data object, wherein: (a) nodes of the graph-based table representation correspond to the plurality of table tokens, and (b) links of the graph-based table representation correspond to cross-token relationships defined by each related token set; (iv) generate, based at least in part on performing one or more defined-pattern graph traversal operations performed on the graph-based table representation, a semantic table representation; and (v) perform one or more prediction-based actions based at least in part on the semantic table representation.

In accordance with yet another aspect, a computer program product is provided. The computer program product may comprise at least one computer-readable storage medium having computer-readable program code portions stored therein, the computer-readable program code portions comprising executable portions configured to: (i) identify a plurality of table tokens of the table data object, wherein each table token is associated with a relative token position measure within the table data object; (ii) for each table token: (a) generate, using a token-wise entity type classification machine learning model, a predicted entity type, wherein: (1) the predicted entity type is selected from a plurality of defined entity types associated with an inter-related entity type taxonomy for the table data object, and (2) the inter-related entity type taxonomy defines, for each defined entity type, a potentially related defined entity type set of the plurality of defined entity types, and (b) generate a related token set of the plurality of table tokens for the table token, wherein: (1) each related table token in the related token set is associated with a corresponding defined entity type that is in the potentially-related defined entity type set, and (2) each related table token in the related token set is selected based at least in part on the relative token position measure for the table token and the relative token position measure for the related table token; (iii) generate, based at least in part on the plurality of table tokens and each related token set, a graph-based table representation for the table data object, wherein: (a) nodes of the graph-based table representation correspond to the plurality of table tokens, and (b) links of the graph-based table representation correspond to cross-token relationships defined by each related token set; (iv) generate, based at least in part on performing one or more defined-pattern graph traversal operations performed on the graph-based table representation, a semantic table representation; and (v) perform one or more prediction-based actions based at least in part on the semantic table representation.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating a semantic table representation for a table data object in accordance with some embodiments discussed herein.

FIGS. 5A-5C provide operational examples of table data objects in accordance with some embodiments discussed herein.

FIG. 6 provides an operational example of a document data object that comprises a table data object in accordance with some embodiments discussed herein.

FIG. 7 provides an operational example of assignment of predicted entity types to table tokens of a depicted table data object in accordance with some embodiments discussed herein.

FIG. 8 provides an operational example of generating a text data object for a table data object in accordance with some embodiments discussed herein.

FIG. 9 provides an operational example of generating relative cell position measures for boundary-separated cells of a table data object in accordance with some embodiments discussed herein.

FIG. 10 provides an operational example of generating predicted entity types and relative token position measures for table tokens of a table data object in accordance with some embodiments discussed herein.

FIG. 11 provides an operational example of generating a predicted entity type sequence for an input table token sequence for a table data object in accordance with some embodiments discussed herein.

FIG. 12 provides an operational example of a graph-based table representation data object for a table data object with a table token that has a root defined entity type in accordance with some embodiments discussed herein.

FIG. 13 provides an operational example of a graph-based table representation data object for a table data object with a table token that does not have a root defined entity type in accordance with some embodiments discussed herein.

FIG. 14 provides an operational example of the set of defined cross-entity-type relationships between a set of defined entity types associated with an inter-related entity type taxonomy in accordance with some embodiments discussed herein.

FIG. 15 provides an operational example of a prediction output user interface that depicts a semantically refined relational table data object for a table data object in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNICAL IMPROVEMENTS

Various embodiments of the present invention make important technical contributions to improving predictive accuracy of natural language processing machine learning models that are configured to perform natural language processing operations on table data objects, which in turn improves training speed and training efficiency of training the noted natural language processing machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, techniques that improve predictive accuracy without harming training speed, such as the techniques described herein, enable improving training speed given a constant predictive accuracy. In doing so, the techniques described herein improving efficiency and speed of training natural language processing machine learning models, thus reducing the number of computational operations needed and/or the amount of training data entries needed to train natural language processing machine learning models. Accordingly, the techniques described herein improve at least one of the computational efficiency, storage-wise efficiency, and speed of training natural language processing machine learning models.

Moreover, various embodiments of the present invention make important technical contributions to improving resource-usage efficiency of post-prediction systems by using semantic table representations to set the number of allowed computing entities used by the noted post-prediction systems. For example, in some embodiments, a predictive data analysis computing entity determines D table classifications for D table data objects based at least in part on the D semantic table representations for the D table data objects. Then, the count of table data objects that are associated with an affirmative table classification, along with a resource utilization ratio for each table data object, can be used to predict a predicted number of computing entities needed to perform post-prediction processing operations (e.g., automated investigation operations) with respect to the D table data objects. For example, in some embodiments, the number of computing entities needed to perform post-prediction processing operations (e.g., automated investigation operations) with respect to D table data objects can be determined based at least in part on the output of the equation: R=ceil(Σₖ^{k=K}urₖ), where R is the predicted number of computing entities needed to perform post-prediction processing operations with respect to the D table data object, ceil(·) is a ceiling function that returns the closest integer that is greater than or equal to the value provided as the input parameter of the ceiling function, k is an index variable that iterates over K table data objects among the D table data that are associated with affirmative classifications, and urₖ is the estimated resource utilization ratio for a kth table data object that may be determined based at least in part on a count of utterances/tokens/words in the kth table data object. In some embodiments, once R is generated, the predictive data analysis computing entity can use R to perform operational load balancing for a server system that is configured to perform post-prediction processing operations (e.g., automated investigation operations) with respect to D table data objects. This may be done by allocating computing entities to the post-prediction processing operations if the number of currently allocated computing entities is below R, and deallocating currently allocated computing entities if the number of currently allocated computing entities is above R.

An exemplary application of various embodiments of the present invention relates to generating an optimal conceptual representation of a table by: (i) analyzing a sequence of table cell values for the table using named entity recognition to identify table entities, (ii) mapping the extracted entities using a graph-based technique that describes hierarchical relationships between the graph entities to generate a table graph, (iii) processing the resulting table graph using a breadth-first-search tree search technique to mine an optimal conceptual relationship set for each extracted entity, and (iv) generating an output representation table in which each row corresponds to the optimal conceptual relationship set for a corresponding table row.

Various embodiments of the present invention are configured to perform the following steps/operations: (i) a table image is converted to a set of table cells using optical character recognition, (ii) a sequence of table cells is analyzed using named entity recognition to identify table entities (e.g., events, sub-events, metrics, frequencies, and/or the like), (iii) extracted entities are embedded using a graph-based technique that maps hierarchical relationships between the graph entities; (iv) resulting graph is processed using a breadth-first search tree search technique to mine an optimal conceptual relationship set for each extracted entity; and (v) the optimal conceptual relationship set is used to construct an output representation table in which each row corresponds to the optimal conceptual relationship set for a corresponding table row.

### II. DEFINITIONS

The term “table data object” may refer to a data construct that describes a computer-readable representation of a table. For example, in some embodiments, the table data object describes an image data object that describes a computer-readable visual representation of a table, such as a computer-readable visual representation that is generated by defining an image segment of an image-based Portable Document Format (PDF) document, a computer-readable visual representation that is generated by capturing an image of a physical paper that includes a table, and/or the like. As another example, in some embodiments, the table data object describes a text data object that describes a computer-readable visual representation of a table, such as a computer-readable visual representation that is generated by defining a text segment of a text-based Portable Document Format (PDF) document, a computer-readable visual representation that is generated by defining a text segment of a Microsoft Word or text editor document, and/or the like. In some embodiments, if the table data object describes an image data object that describes a computer-readable visual representation of a table, one or more optical character recognition operations are performed on the image data object to generate a text data object for the table data object that describes a computer-readable visual representation of a table. In some embodiments, a table data object is detected by processing an image data object using an object detection machine learning model, such as using a You Only Look Once (YOLO) Real-Time Object Detection machine learning model that is trained using a table object detection training task in order to detect table objects in image data objects.

The term “table token” may refer to a data construct that describes a semantic/conceptual unit of text data associated with the table data object. In some embodiments, to generate the table tokens of the table data object, a text data object is first generated/identified for the table data object, for example by performing optical character recognition operations on an image data object of the table data object. In some embodiments, once the text data object for a table data object is generated/identified, then the text data object is segmented into the plurality of tokens, for example by assigning a text segment comprising one or more contiguous words of the text data object to a respective table token if the text segment matches a defined dictionary term in an acceptable table token dictionary table, and/or by performing one or more named entity recognition operations on the text data object and assigning each contiguous text segment of the text data object that is extracted/identified as being an entity by the named entity recognition operations to a table data object. In some embodiments, to generate the table tokens for a table data object, an entity detection machine learning model is used to generate, for each n-gram of the text input data object for the table data object that comprises an n-sized pairing of the words of the input data object (where n may have a range that is defined by the hyperparameters of the entity detection machine learning model, and further where each n-sized pairing may in some embodiments include non-contiguous words that are within a threshold proximity), an entity detection score that describes a predicted likelihood that the n-gram is an entity that should be assigned to a respective table token. In some of the noted embodiments, once the entity detection machine learning model generates a respective entity detection score for each processed n-gram of the text data object, then those n-grams that are associated with the highest entity detection scores are selected to be assigned to table tokens in a manner that is configured to ensure that no word is assigned to more than one table token. For example, if a text data object for a table data object comprises the three words W1, W2, and W3, and if the defined range for n is {1, 2}, and further if: (i) the n-gram W1 has an entity detection score of 0.9, (ii) the n-gram W2 has an entity detection score of 0.2, (iii) the n-gram W2 has an entity detection score of 0.3, (vi) the n-gram W1-W2 has an entity detection score of 0.8, (v) the n-gram W2-W3 has an entity detection score of 0.9, and (iv) the n-gram W1-W3 has an entity detection score of 0.3, then the generated table tokens of the table data object may comprise a first table token comprising W1 and a second table token comprising W2 and W3.

The term “relative cell position measure” may refer to a data construct that describes a relative position of a boundary-separated table cell of a table data object as determined based at least in part on a visual/organizational configuration/scheme of the table data object. In some embodiments, the text ordering of a text sequence for a text data object that is associated with a table data object is determined based at least in part on relative cell position measures of text segments associated with the text data object within the table data object. For example, in some embodiments, each boundary-separated cell of a table data object is assigned a two-dimensional relative cell position measure, where a first dimension value of the two-dimensional relative cell position measure for a boundary-separated cell is determined based at least in part on a relative vertical position of the boundary-separated cell, and second dimension value of the two-dimensional relative cell position measure for a boundary-separated cell is determined based at least in part on a relative horizontal position of the boundary-separated cell. In some of the noted embodiments, given a first boundary-separated cell that is associated with the first dimension value m₁ and a second dimension value n₁, and a second boundary-separated cell that is associated with the first dimension value m₂ and a second dimension value n₂, then: (i) if m₁+n₁<m₂+n₂, then the text segment for the first boundary-separated cell appears before the text segment for the second boundary-separated cell in the text ordering, (ii) if m₁+n₁>m₂+n₂, then the text segment for the second boundary-separated cell appears before the text segment for the first boundary-separated cell in the text ordering, (iii) if m₁+n₁=m₂+n₂ and n₁<n₂, then the text segment for the first boundary-separated cell appears before the text segment for the second boundary-separated cell in the text ordering, and (iv) if m₁+n₁=m₂+n₂ and n₁>n₂, then the text segment for the second boundary-separated cell appears before the text segment for the first boundary-separated cell in the text ordering. In some embodiments, within the text segment of a boundary separated cell, the relative ordering of the common-celled words is determined based at least in part on the output character recognition sequence as described above. For example, consider a boundary-separated cell that is associated with the output character recognition subsequence “Base Administrative Fees,” where the boundary-separated cell is associated with the two-dimensional relative cell position measure (2, 0) within a corresponding table data object. In this example, the text ordering of the table data object may reflect the subsequence “Base Administrative Fees” after the text segment for the boundary-separated cell with the two-dimensional relative cell position measure (1, 1) but before the text segment for the boundary-separated cell with the two-dimensional relative cell position measure (2, 1).

The term “relative token position measure” may refer to a data construct that describes a relative position of a corresponding table token in relation to the other table tokens of a table data object as determined based at least in part on a visual/organizational configuration/scheme of the table data object. For example, in some embodiments, where each table data object may be associated with a boundary-separated table cell of the corresponding table data object, and further where the boundary-separated table cell is associated with a relative cell position measure, the relative token position measure of the table token may be generated based at least in part on (e.g., may comprise) the relative cell position measure of the boundary-separated table cell that is associated with the particular table token. In some embodiments, the relative token position measure of a table token that is part of the text segment of a particular boundary-separated table cell is represented by the value pair {m, n}, where m is the relative horizontal position of the particular boundary-separated table cell, and n is the relative horizontal position of the particular boundary-separated table cell. In some embodiments, the relative token position measure of a table token that is part of the text segment of a particular boundary-separated table cell is represented by the value pair {m, n, k}, where m is the relative horizontal position of the particular boundary-separated table cell, n is the relative horizontal position of the particular boundary-separated table cell, and k is the relative position of the table token within an intra-cell text sequence of the text segment of the particular boundary-separated table cell. In some embodiments, the relative token position measure of a table token is represented by the value pair {m, n}, where m is a relative horizontal position of a centroid pixel of an image segment of the table token, and n is a relative vertical position of the noted centroid pixel.

The term “predicted entity type” may refer to a data construct that describes a mapping of a table token to a set of defined entity types defined by an inter-related entity type taxonomy. Examples of defined entity types associated with an inter-related entity type taxonomy include a root key performance indicator (KPI) entity type that is assigned to table tokens associated with table headers defining context of information described by table data objects, a KPI entity type that is assigned to table tokens describing section headers of tables, a sub-KPI entity that type that is assigned to table tokens describing metrics that qualitatively and/or quantitively define KPIs, a value entity type that is assigned to table tokens describing qualitative and/or quantitative measurements of sub-KPIs, a unit entity type that is assigned to table tokens describing measurement units for values, and a timeframe entity type that is assigned table tokens describing time spans/ranges for sub-KPIs and/or for values. In some embodiments, each table data object having a particular table type (e.g., a particular table type that is determined based at least in part on a document type of the document data object that comprises the table data object and/or based at least in part on a task type of a predictive data analysis task in which the table data object is used as an input) is associated with a distinct inter-related entity type taxonomy for the table type, and thus different table data objects may be associated with different sets of defined entity types. In this way, distinct inter-related entity type taxonomies that define distinct defined entity type sets enable representing/transferring subject-matter-specific and/or domain-specific insights about document types and/or task types into generating semantic table representations for table data objects and using the noted semantic table representations as part of data predictive data analysis operations that use the table data objects as inputs.

The term “inter-related entity type taxonomy” may refer to a data construct that describes a set of defined entity types that may be assigned to table tokens of a related table data object along with a set of cross-entity-type relationships between pairs if defined entity types. For example, a particular inter-related entity type taxonomy may define: (i) a set of defined entity types comprising a root KPI entity type, a KPI entity type, a sub-KPI entity type, a value entity type, a unit entity type, and a timeframe entity type, and (ii) a cross-entity-type relationship between the root KPI entity type and the KPI entity type, a cross-entity-type relationship between the KPI entity type and the sub-KPI entity type, a cross-entity-type relationship between the sub-KPI entity type and the unit entity type, a cross-entity-type relationship between the unit entity type and the value entity type, and a cross-entity-type relationship between the value entity type and the timeframe entity type. Accordingly, the inter-related entity type taxonomy may define, for each particular defined entity type, a potentially related defined entity type set which includes each other defined entity type that has a cross-entity-type relationship with the particular defined entity type. For example, if a particular inter-related entity type taxonomy may define: (i) a set of defined entity types comprising a root KPI entity type, a KPI entity type, a sub-KPI entity type, a value entity type, a unit entity type, and a timeframe entity type, and (ii) a cross-entity-type relationship between the root KPI entity type and the KPI entity type, a cross-entity-type relationship between the KPI entity type and the sub-KPI entity type, a cross-entity-type relationship between the sub-KPI entity type and the unit entity type, a cross-entity-type relationship between the unit entity type and the value entity type, and a cross-entity-type relationship between the value entity type and the timeframe entity type, then: (i) the potentially-related defined entity type set for the root KPI entity type comprises the KPI entity type, (ii) the potentially-related defined entity type set for the KPI entity type comprises the root KPI entity type and the sub-KPI entity type, (iii) potentially-related defined entity type set for the sub-KPI entity type comprises the KPI entity type and the unit entity type, (iv) the potentially-related defined entity type set for the unit entity type comprises the sub-KPI entity type and the value entity type, (v) the potentially-related defined entity type set for the value entity type comprises the unit entity type and the timespan entity type, and (vi) the potentially-related defined entity type set for the timespan entity type comprises the value entity type.

The term “token-wise entity type classification machine learning model” may refer to a data construct that describes parameters, hyperparameters, and/or defined operations of a machine learning model that is configured to process a table token to generate a predicted entity type for the table token. In some of the noted embodiments, the predicted entity type is selected from a plurality of defined entity types associated with an inter-related entity type taxonomy for the table data object, and the inter-related entity type taxonomy defines, for each defined entity type, a potentially related defined entity type set of the plurality of defined entity types. In some embodiments, the token-wise entity type classification machine learning model is a sequence-to-sequence machine learning model (e.g., a sequence-to-sequence neural network machine learning model such as a Long Short Term Memory machine learning model) that is configured to process a sequence of token representations associated with an input table token sequence of the table tokens of a table to generate an output entity type sequence that describes, for each table token in the input table token sequence, the predicted entity type for the table token. For example, in some embodiments, at each tth timestep of T timesteps (where T may be the number of table tokens of the table data objects), the token-wise entity type classification machine learning model processes the table token representation vector (e.g., a bag-of-words representation vector) of a tth table token in the input table token sequence to generate an E-sized vector for the tth table token, where E is the number of defined token types defined by a corresponding inter-related token type taxonomy, and where each eth value of the E-sized vector for the tth table token corresponds to a respective eth defined token type of the E defined token types and describes a predicted likelihood score that the tth table token is associated with the eth defined token type. In some embodiments, the predicted entity type for a tth table token is the defined entity type whose corresponding predicted likelihood score is the highest value of the E-sized vector for the tth table token as generated by the token-wise entity type classification machine learning model. In some embodiments, the token-wise entity type classification machine learning model is trained using a gradient-descent-based training routine and based at least in part on training data generated using ground-truth entity types for table tokens of entity-tagged table data objects (e.g., entity-tagged table data objects generated using historical data, using annotation/tagging data provided by subject matter experts, using annotation/tagging data provided by named-entity-recognition-based heuristics, using annotation/tagging data provided by regular-expression-based heuristics, using annotation/tagging data provided by dictionary-mapping-based heuristics, and/or the like).

The term “graph-based table representation” may refer to a data construct that describes a computer-readable graph structure in which table tokens of a corresponding table data object are nodes/vertices of the graph structure and in which relationships/edges exists between node pairs whose corresponding entity pairs are determined to be related based at least in part on at least some of the techniques described herein. In some embodiments, a node N1 that is associated with a table token T1 having a defined entity type E1 is linked to a node N2 that is associated with a table token T2 having a defined entity type E2 in the graph-based table representation if: (i) E1 and E2 are determined to be potentially related (i.e., E1 is in the potentially-related defined entity type set for E2, E2 is in the potentially-related defined entity type set for E1, both E1 is in the potentially-related defined entity type set for E2 and E1 is in the potentially-related defined entity type set for E2, and/or the like), (ii) the relative token position measure for T1 and the relative token position measure for T2 satisfy one or more defined token proximity criteria. In some of the noted embodiments, if a corresponding inter-related entity type taxonomy defines that an E2-typed table token can relate to at most one E1-typed table token (e.g., which could happen if E1 is deemed to be a parent type of E2, for example if the root-KPI entity type is deemed to be a parent of the KIP entity type), then the defined token proximity criteria may include a criterion that is determined based at least in part on whether T1 is the E1-typed table token having the highest cross-token proximity score with respect to T2. In some, if a corresponding inter-related entity type taxonomy defines that an E1-typed table token can relate to more than one E2-typed table token (e.g., which could happen if E2 is deemed to be a child/grandchild/nth-degree-child type of E1, for example if the KIP entity type is deemed to be a child type of the root-KPI entity type), then the defined token proximity criteria may include a criterion that is determined based at least in part on whether the cross-token proximity score for T1 and T2 satisfies (e.g., exceeds) a cross-token proximity score threshold.

The term “cross-token proximity score” may refer to a data construct that describes a measure of positional/organizational proximity of table portions associated with two table tokens within a corresponding table token. In some embodiments, the cross-token proximity score for a pair of table tokens is a weighted combination of a set of proximity indicators, such as a proximity indicator that is determined based at least in part on an inverse of a distance measure between relative token position measures for the pair, an inverse of a distance measure between relative centroid pixel values for the pair, a proximity indicator that has a value of one if the pair are in the same boundary-separated table cell, a proximity indicator that has a value of one if the pair are in the same boundary-separated table row, a proximity indicator that has a value of one if the pair are in the same boundary-separated table column, a proximity indicator that has a value of one if one table token in the pair is in a table header of a table portion that comprises a second table token in the table pair, and/or the like.

The term “semantic table representation” may refer to a data construct that describes semantic relationships between table tokens/entities of a table based at least in part on expected potential relationships between those tokens/entities as determined based at least in part on predicted entity types of those tokens/entities. In some embodiments, a semantic table representation is generated using a token-wise entity type classification mechanism whose output space is defined by a set of defined entity types characterized by an inter-related entity type taxonomy to generate a representation of a table data object that describes per-token semantic inferences and cross-token semantic inferences performed on the table data object in accordance with subject-matter-domain insights as described by the inter-related entity type taxonomy. In some embodiments, a predictive data analysis computing entity generates the semantic table representation for the table data object by performing one or more defined-pattern graph traversal operations performed on the graph-based table representation. In some embodiments, the one or more defined-pattern graph traversal operations comprise one or more breadth first search graph traversal operations. In some embodiments, the one or more defined-pattern graph traversal operations comprise one or more depth first search graph traversal operations.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

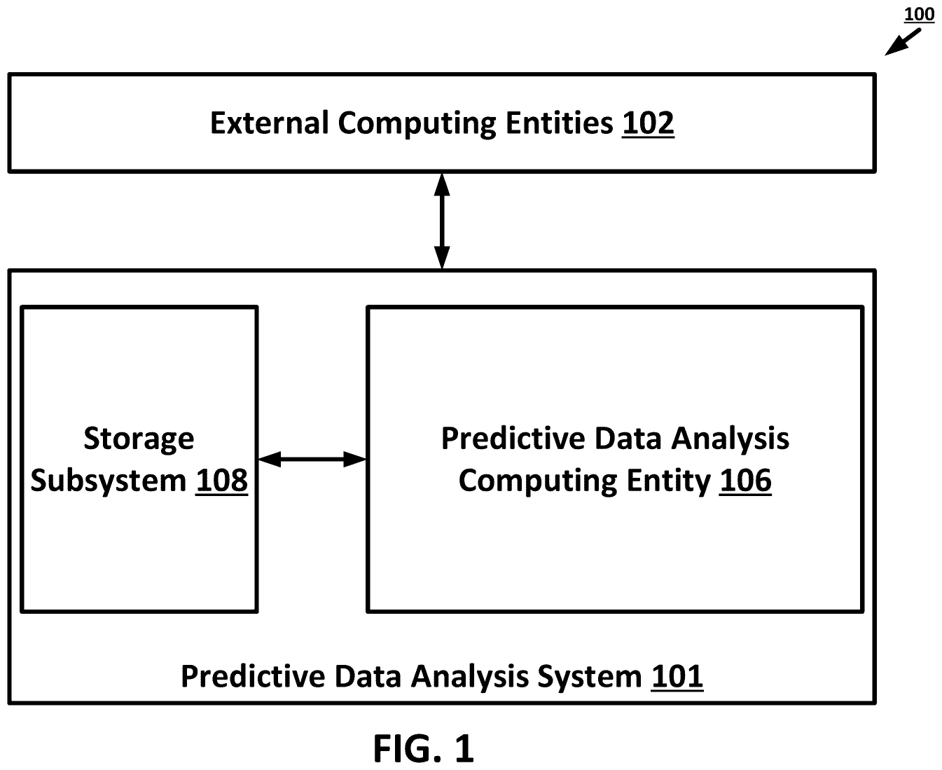

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions.

An example of a prediction-based action that can be performed using the predictive data analysis system 101 is a request for generating a diagnosis code for a clinical text. For example, in accordance with various embodiments of the present invention, a using multi-context self-attention machine learning framework can use various distinct context window sizes to capture predictive insights about various potential segmenting/separation logics that can be imposed on an input text sequence. This technique will lead to higher accuracy of performing natural language processing operations on input sequences with long sizes and/or with insufficient presences of separator tokens. In doing so, the techniques described herein improving efficiency and speed of training natural language processing machine learning models, thus reducing the number of computational operations needed and/or the amount of training data entries needed to train natural language processing machine learning models. Accordingly, the techniques described herein improve at least one of the computational efficiency, storage-wise efficiency, and speed of training natural language processing machine learning models.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

A. Exemplary Predictive Data Analysis Computing Entity

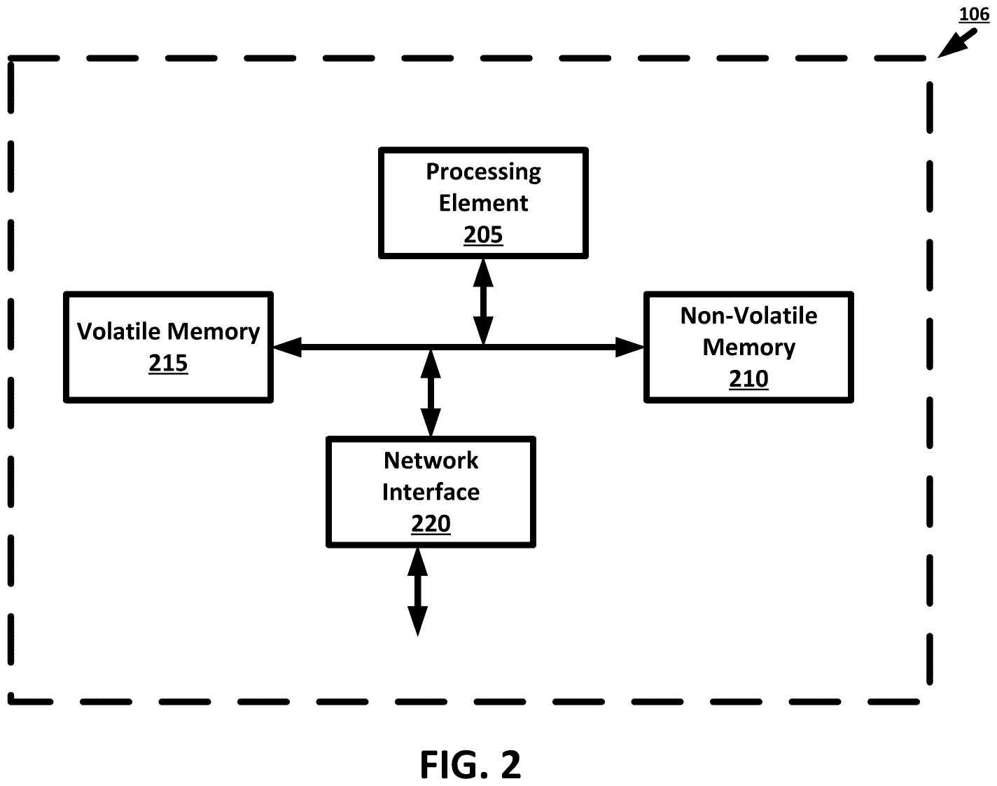

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity— relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

B. Exemplary Client Computing Entity

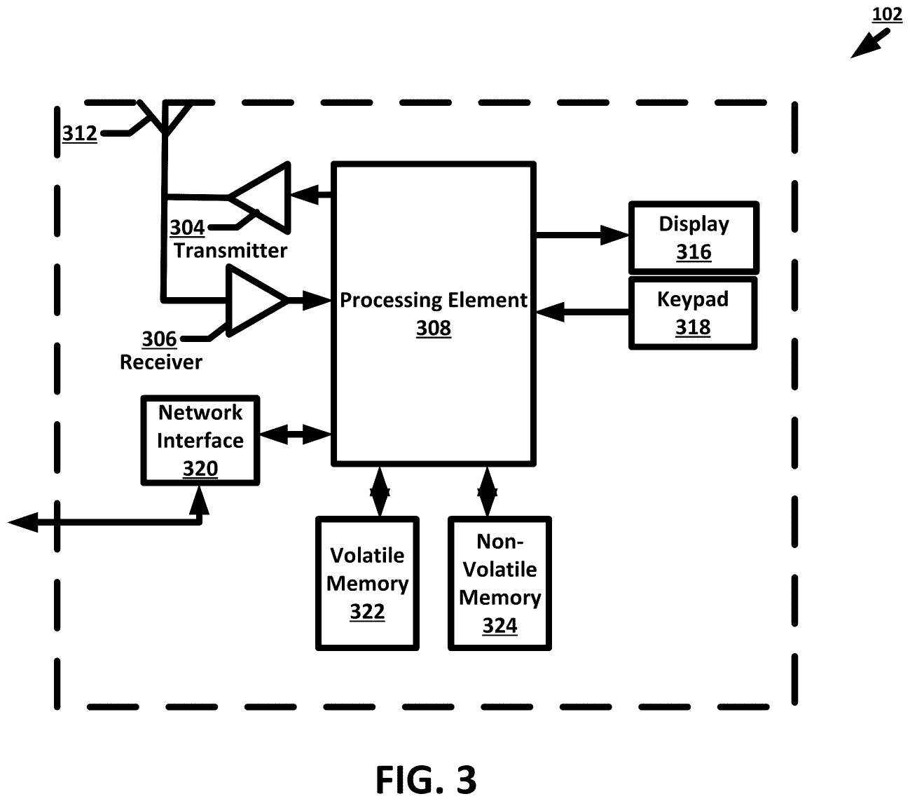

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Various embodiments of the present invention make important technical contributions to improving predictive accuracy of natural language processing machine learning models, which in turn improves training speed and training efficiency of training natural language processing machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, techniques that improve predictive accuracy without harming training speed, such as the techniques described herein, enable improving training speed given a constant predictive accuracy. In doing so, the techniques described herein improving efficiency and speed of training natural language processing machine learning models, thus reducing the number of computational operations needed and/or the amount of training data entries needed to train natural language processing machine learning models. Accordingly, the techniques described herein improve at least one of the computational efficiency, storage-wise efficiency, and speed of training natural language processing machine learning models.

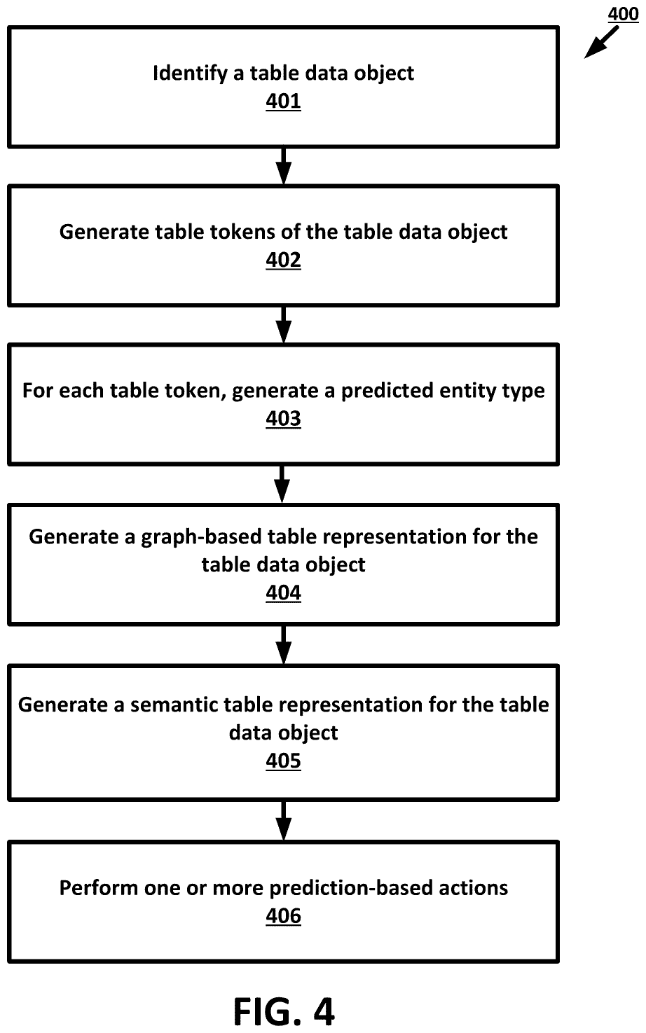

FIG. 4 is a flowchart diagram of an example process 400 for generating a semantic table representation for a table data object. Via the various steps/operations of the process 400, the predictive data analysis computing entity 106 can perform natural language processing operations using a token-wise entity type classification mechanism whose output space is defined by a set of defined entity types characterized by an inter-related entity type taxonomy to generate a representation of a table data object that describes per-token semantic inferences and cross-token semantic inferences performed on the table data object in accordance with subject-matter-domain insights as described by the inter-related entity type taxonomy.

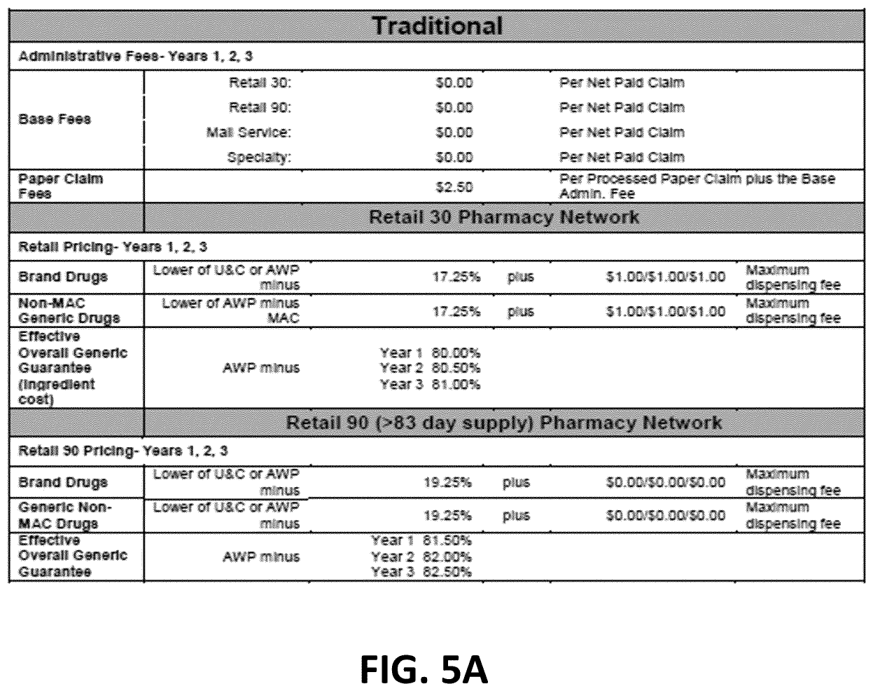

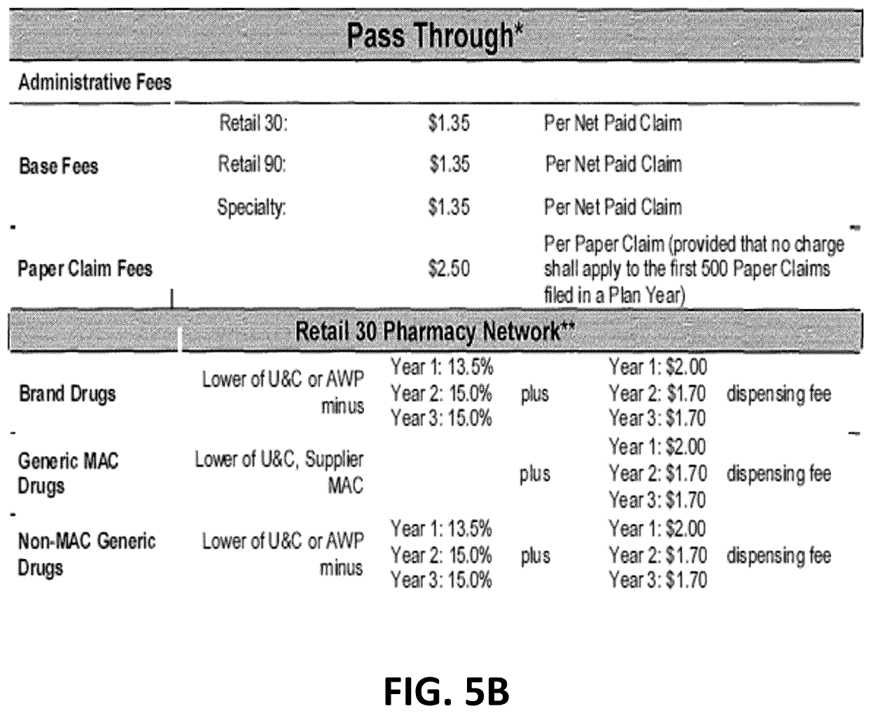

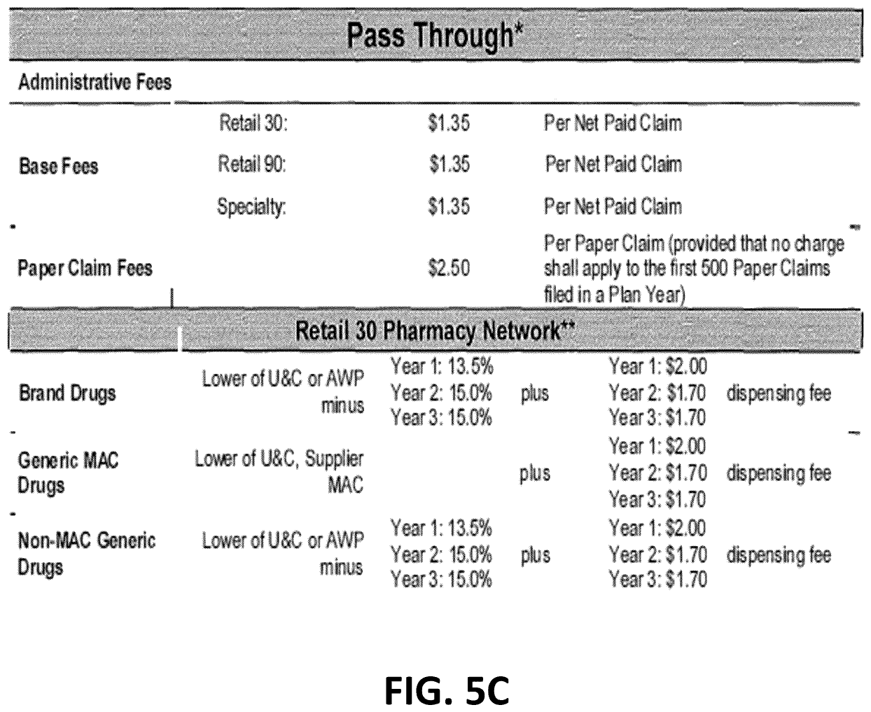

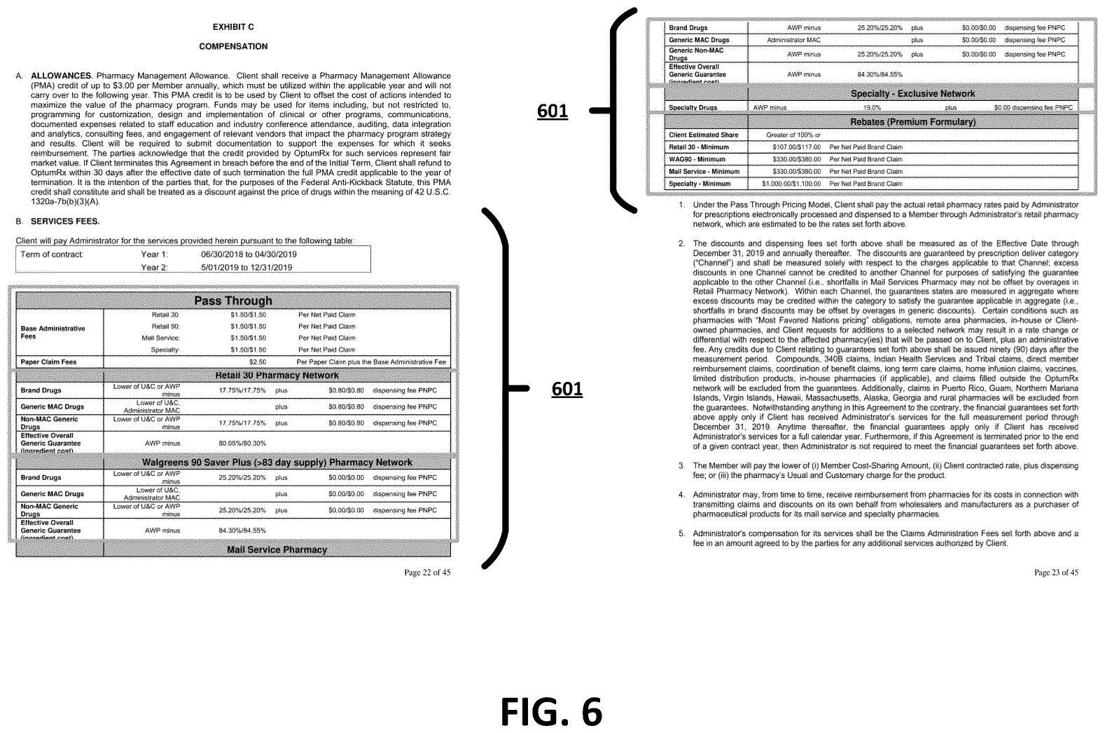

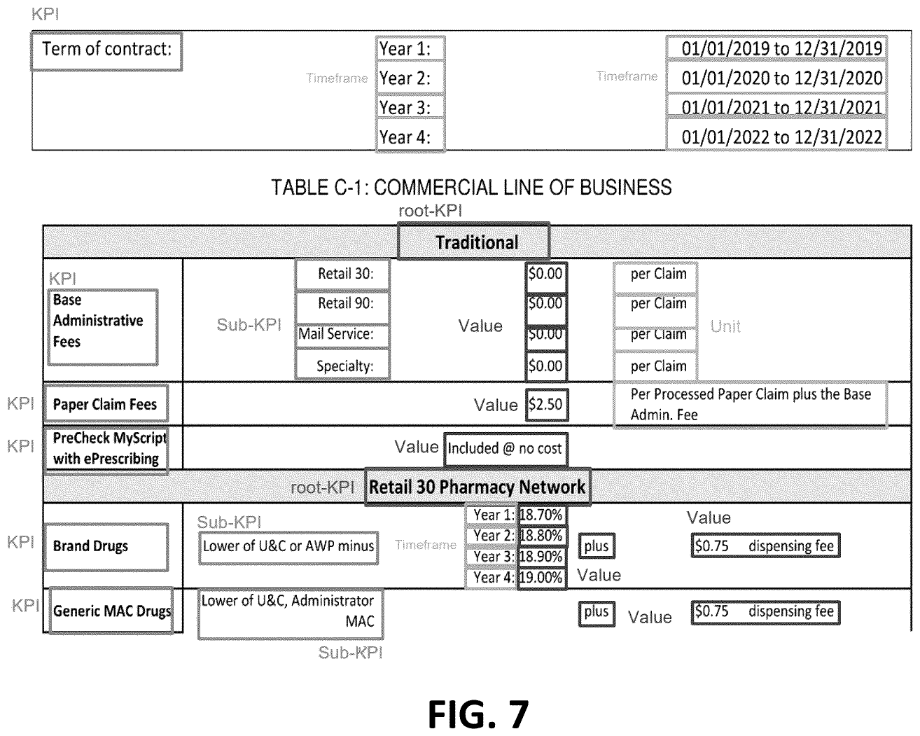

The process 400 begins at step/operation 401 when the predictive data analysis computing entity 106 identifies (e.g., receives, captures, generates, retrieves, and/or the likes) the table data object. Operational examples of table data objects are depicted in FIGS. 5A-5C, in the table data objects 601 of the document data object that is depicted in FIG. 6, and in FIG. 7. In some embodiments, the table data object is identified using one or more table identification operations.

In some embodiments, a table data object describes a computer-readable representation of a table. For example, in some embodiments, the table data object describes an image data object that describes a computer-readable visual representation of a table, such as a computer-readable visual representation that is generated by defining an image segment of an image-based Portable Document Format (PDF) document, a computer-readable visual representation that is generated by capturing an image of a physical paper that includes a table, and/or the like. In some embodiments, a table data object is detected by processing an image data object using an object detection machine learning model, such as using a You Only Look Once (YOLO) Real-Time Object Detection machine learning model that is trained using a table object detection training task in order to detect table objects in image data objects.

As another example, in some embodiments, the table data object describes a text data object that describes a computer-readable visual representation of a table, such as a computer-readable visual representation that is generated by defining a text segment of a text-based Portable Document Format (PDF) document, a computer-readable visual representation that is generated by defining a text segment of a Microsoft Word or text editor document, and/or the like. In some embodiments, if the table data object describes an image data object that describes a computer-readable visual representation of a table, one or more optical character recognition operations are performed on the image data object to generate a text data object for the table data object that describes a computer-readable visual representation of a table.

At step/operation 402, the predictive data analysis computing entity 106 generates a set of table tokens of the table data object. In some embodiments, each table token is a semantic/conceptual unit of text data associated with the table data object. In some embodiments, to generate the table tokens of the table data object, a text data object is first generated/identified for the table data object, for example by performing optical character recognition operations on an image data object of the table data object. In some embodiments, once the text data object for a table data object is generated/identified, then the text data object is segmented into the plurality of tokens, for example by assigning a text segment comprising one or more contiguous words of the text data object to a respective table token if the text segment matches a defined dictionary term in an acceptable table token dictionary table, and/or by performing one or more named entity recognition operations on the text data object and assigning each contiguous text segment of the text data object that is extracted/identified as being an entity by the named entity recognition operations to a table data object.

In some embodiments, to generate the table tokens for a table data object, an entity detection machine learning model is used to generate, for each n-gram of the text input data object for the table data object that comprises an n-sized pairing of the words of the input data object (where n may have a range that is defined by the hyperparameters of the entity detection machine learning model, and further where each n-sized pairing may in some embodiments include non-contiguous words that are within a threshold proximity), an entity detection score that describes a predicted likelihood that the n-gram is an entity that should be assigned to a respective table token. In some of the noted embodiments, once the entity detection machine learning model generates a respective entity detection score for each processed n-gram of the text data object, then those n-grams that are associated with the highest entity detection scores are selected to be assigned to table tokens in a manner that is configured to ensure that no word is assigned to more than one table token.

For example, if a text data object for a table data object comprises the three words W1, W2, and W3, and if the defined range for n is {1, 2}, and further if: (i) the n-gram W1 has an entity detection score of 0.9, (ii) the n-gram W2 has an entity detection score of 0.2, (iii) the n-gram W2 has an entity detection score of 0.3, (vi) the n-gram W1-W2 has an entity detection score of 0.8, (v) the n-gram W2-W3 has an entity detection score of 0.9, and (iv) the n-gram W1-W3 has an entity detection score of 0.3, then the generated table tokens of the table data object may comprise a first table token comprising W1 and a second table token comprising W2 and W3.

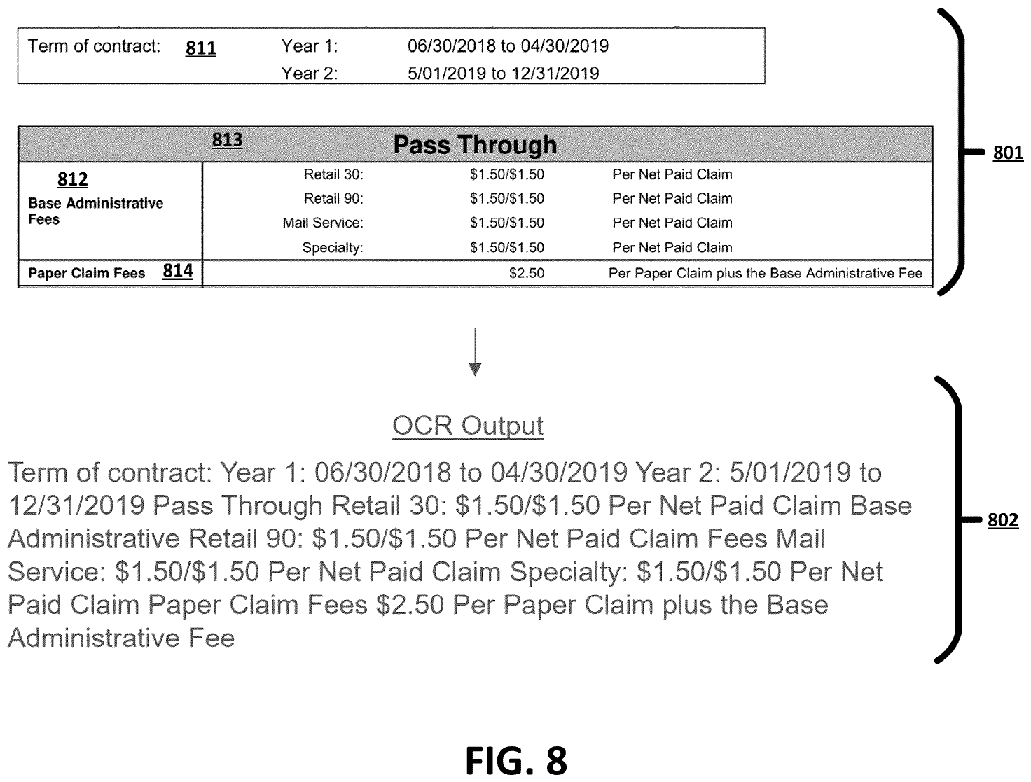

An operational example of a text data object 802 that is generated by performing optical character recognition operations on a table data object 801 that is an image data object is generated in FIG. 8. In some embodiments, the text data object 802 is an ordered text sequence that has an ordering, where the ordering of the text data object is generated based at least in part on an ordering of an optical character recognition output sequence resulting from performing one or more optical character recognition operations on an image data object associated with the table data object. For example, as depicted in FIG. 8, in accordance with the ordering of the text data object 802, the term “Term of contract:” appears before the term “Year 1:”.

In some embodiments, the text data object that describes text data associated with a table data object is associated with an ordered text sequence. As described above with respect to FIG. 7, in some embodiments, the ordering of the text data object is defined by the ordering of the optical character recognition output resulting from performing one or more optical character recognition operations on an image data object associated with the table data object. For example, in some embodiments, if the word W1 appears immediately before the word W2 in an output character recognition output sequence resulting from performing one or more optical character recognition operations on an image data object associated with the table data object, then the text sequence associated with the text data object for the table data object reflects this sequential relationship in which W1 appears immediately before W2.

In some embodiments, the text ordering of a text sequence for a text data object that is associated with a table data object is determined based at least in part on relative cell position measures of text segments associated with the text data object within the table data object. For example, in some embodiments, each boundary-separated cell of a table data object is assigned a two-dimensional relative cell position measure, where a first dimension value of the two-dimensional relative cell position measure for a boundary-separated cell is determined based at least in part on a relative vertical position of the boundary-separated cell, and second dimension value of the two-dimensional relative cell position measure for a boundary-separated cell is determined based at least in part on a relative horizontal position of the boundary-separated cell. In some of the noted embodiments, given a first boundary-separated cell that is associated with the first dimension value m₁ and a second dimension value n₁, and a second boundary-separated cell that is associated with the first dimension value m₂ and a second dimension value n₂, then: (i) if m₁+n₁<m₂+n₂, then the text segment for the first boundary-separated cell appears before the text segment for the second boundary-separated cell in the text ordering, (ii) if m₁+n₁>m₂+n₂, then the text segment for the second boundary-separated cell appears before the text segment for the first boundary-separated cell in the text ordering, (iii) if m₁+n₁=m₂+n₂ and n₁<n₂, then the text segment for the first boundary-separated cell appears before the text segment for the second boundary-separated cell in the text ordering, and (iv) if m₁+n₁=m₂+n₂ and n₁>n₂, then the text segment for the second boundary-separated cell appears before the text segment for the first boundary-separated cell in the text ordering. In some embodiments, within the text segment of a boundary separated cell, the relative ordering of the common-celled words is determined based at least in part on the output character recognition sequence as described above.

For example, consider a boundary-separated cell that is associated with the output character recognition subsequence “Base Administrative Fees,” where the boundary-separated cell is associated with the two-dimensional relative cell position measure (2, 0) within a corresponding table data object. In this example, the text ordering of the table data object may reflect the subsequence “Base Administrative Fees” after the text segment for the boundary-separated cell with the two-dimensional relative cell position measure (1, 1) but before the text segment for the boundary-separated cell with the two-dimensional relative cell position measure (2, 1).

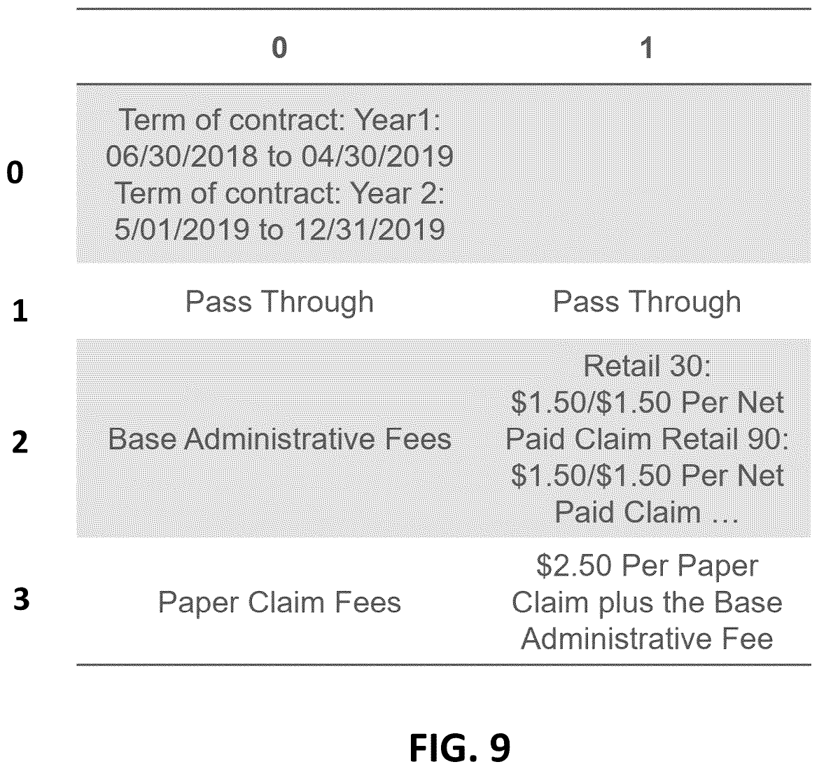

An operational example of relative cell position measures for boundary-separated cells of the table data object 801 is depicted in FIG. 9. For example, as depicted in FIG. 9, the boundary-separated table cell 811 is associated with the relative cell position measure (0, 0), the boundary-separated table cell 812 is associated with the relative cell position measure (2, 0), the boundary-separated table cell 813 is associated with the relative cell position measures of both (1, 1) and (1, 2) because it spans across the horizontal range of the table data object 801, and the boundary-separated table cell 814 is associated with the relative cell position measure of (3, 1).

In some embodiments, each table token is associated with a relative token position measure within the table data object. In some embodiments, a relative token position measure describes a relative position of a corresponding table token in relation to the other table tokens of the table data object as determined based at least in part on a visual/organizational configuration/scheme of the table data object. For example, in some embodiments, where each table data object may be associated with a boundary-separated table cell of the corresponding table data object, and further where the boundary-separated table cell is associated with a relative cell position measure, the relative token position measure of the table token may be generated based at least in part on (e.g., may comprise) the relative cell position measure of the boundary-separated table cell that is associated with the particular table token.

In some embodiments, the relative token position measure of a table token that is part of the text segment of a particular boundary-separated table cell is represented by the value pair {m, n}, where m is the relative horizontal position of the particular boundary-separated table cell, and n is the relative horizontal position of the particular boundary-separated table cell. In some embodiments, the relative token position measure of a table token that is part of the text segment of a particular boundary-separated table cell is represented by the value pair {m, n, k}, where m is the relative horizontal position of the particular boundary-separated table cell, n is the relative horizontal position of the particular boundary-separated table cell, and k is the relative position of the table token within an intra-cell text sequence of the text segment of the particular boundary-separated table cell. In some embodiments, the relative token position measure of a table token is represented by the value pair {m, n}, where m is a relative horizontal position of a centroid pixel of an image segment of the table token, and n is a relative vertical position of the noted centroid pixel.

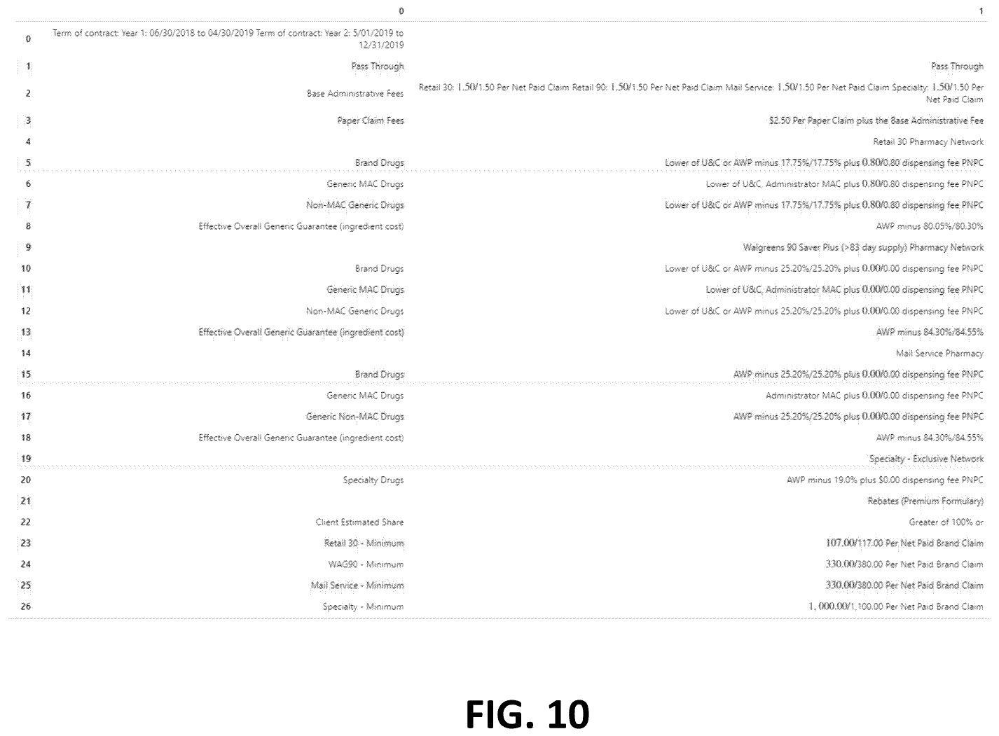

Operational examples of relative token position measures for table tokens of the table data object 801 are depicted in FIG. 10. As depicted in FIG. 10, each table token (corresponding to a respective non-header row of the depicted table) is associated with a relative token position measure that is depicted by a corresponding value in the index column of the depicted table. For example, because the table token “Term of contract:” is associated with the boundary-separated table cell 811 which is in turn associated with the relative cell position measure (0, 0), the noted table token is also associated with the relative token position measure. For example, because the table token “Term of contract:” is associated with the boundary-separated table cell 811 which is in turn associated with the relative cell position measure (0, 0), the noted table token is also associated with the relative token position measure of (0, 0). As another example, because the term “Base Administrative Fees” is associated with the boundary-separated table cell 812 which is in turn associated with the relative cell position measure (2, 0), the noted table token is also associated with the relative token position measure of (2, 0).

Returning to FIG. 4, at step/operation 403, the predictive data analysis computing entity 106 generates a predicted entity type for each table token of the table data object. In some embodiments, a predicted entity type of a table token describes a mapping of the particular table token to a set of defined entity types defined by an inter-related entity type taxonomy. Examples of defined entity types associated with an inter-related entity type taxonomy include a root key performance indicator (KPI) entity type that is assigned to table tokens associated with table headers defining context of information described by table data objects, a KPI entity type that is assigned to table tokens describing section headers of tables, a sub-KPI entity that type that is assigned to table tokens describing metrics that qualitatively and/or quantitively define KPIs, a value entity type that is assigned to table tokens describing qualitative and/or quantitative measurements of sub-KPIs, a unit entity type that is assigned to table tokens describing measurement units for values, and a timeframe entity type that is assigned table tokens describing time spans/ranges for sub-KPIs and/or for values.

In some embodiments, each table data object having a particular table type (e.g., a particular table type that is determined based at least in part on a document type of the document data object that comprises the table data object and/or based at least in part on a task type of a predictive data analysis task in which the table data object is used as an input) is associated with a distinct inter-related entity type taxonomy for the table type, and thus different table data objects may be associated with different sets of defined entity types. In this way, distinct inter-related entity type taxonomies that define distinct defined entity type sets enable representing/transferring subject-matter-specific and/or domain-specific insights about document types and/or task types into generating semantic table representations for table data objects and using the noted semantic table representations as part of data predictive data analysis operations that use the table data objects as inputs.

In some embodiments, an inter-related entity type taxonomy describes a set of defined entity types that may be assigned to table tokens of a related table data object along with a set of cross-entity-type relationships between pairs if defined entity types. For example, a particular inter-related entity type taxonomy may define: (i) a set of defined entity types comprising a root KPI entity type, a KPI entity type, a sub-KPI entity type, a value entity type, a unit entity type, and a timeframe entity type, and (ii) a cross-entity-type relationship between the root KPI entity type and the KPI entity type, a cross-entity-type relationship between the KPI entity type and the sub-KPI entity type, a cross-entity-type relationship between the sub-KPI entity type and the unit entity type, a cross-entity-type relationship between the unit entity type and the value entity type, and a cross-entity-type relationship between the value entity type and the timeframe entity type. Accordingly, the inter-related entity type taxonomy may define, for each particular defined entity type, a potentially related defined entity type set which includes each other defined entity type that has a cross-entity-type relationship with the particular defined entity type.

For example, if a particular inter-related entity type taxonomy may define: (i) a set of defined entity types comprising a root KPI entity type, a KPI entity type, a sub-KPI entity type, a value entity type, a unit entity type, and a timeframe entity type, and (ii) a cross-entity-type relationship between the root KPI entity type and the KPI entity type, a cross-entity-type relationship between the KPI entity type and the sub-KPI entity type, a cross-entity-type relationship between the sub-KPI entity type and the unit entity type, a cross-entity-type relationship between the unit entity type and the value entity type, and a cross-entity-type relationship between the value entity type and the timeframe entity type, then: (i) the potentially-related defined entity type set for the root KPI entity type comprises the KPI entity type, (ii) the potentially-related defined entity type set for the KPI entity type comprises the root KPI entity type and the sub-KPI entity type, (iii) potentially-related defined entity type set for the sub-KPI entity type comprises the KPI entity type and the unit entity type, (iv) the potentially-related defined entity type set for the unit entity type comprises the sub-KPI entity type and the value entity type, (v) the potentially-related defined entity type set for the value entity type comprises the unit entity type and the timespan entity type, and (vi) the potentially-related defined entity type set for the timespan entity type comprises the value entity type.

In some embodiments, a token-wise entity type classification machine learning model is configured to process a table token to generate a predicted entity type for the table token. In some of the noted embodiments, the predicted entity type is selected from a plurality of defined entity types associated with an inter-related entity type taxonomy for the table data object, and the inter-related entity type taxonomy defines, for each defined entity type, a potentially related defined entity type set of the plurality of defined entity types. In some embodiments, the token-wise entity type classification machine learning model is a sequence-to-sequence machine learning model (e.g., a sequence-to-sequence neural network machine learning model such as a Long Short Term Memory machine learning model) that is configured to process a sequence of token representations associated with an input table token sequence of the table tokens of a table to generate an output entity type sequence that describes, for each table token in the input table token sequence, the predicted entity type for the table token. For example, in some embodiments, at each tth timestep of T timesteps (where T may be the number of table tokens of the table data objects), the token-wise entity type classification machine learning model processes the table token representation vector (e.g., a bag-of-words representation vector) of a tth table token in the input table token sequence to generate an E-sized vector for the tth table token, where E is the number of defined token types defined by a corresponding inter-related token type taxonomy, and where each eth value of the E-sized vector for the tth table token corresponds to a respective eth defined token type of the E defined token types and describes a predicted likelihood score that the tth table token is associated with the eth defined token type.

In some embodiments, the predicted entity type for a tth table token is the defined entity type whose corresponding predicted likelihood score is the highest value of the E-sized vector for the tth table token as generated by the token-wise entity type classification machine learning model. In some embodiments, the token-wise entity type classification machine learning model is trained using a gradient-descent-based training routine and based at least in part on training data generated using ground-truth entity types for table tokens of entity-tagged table data objects (e.g., entity-tagged table data objects generated using historical data, using annotation/tagging data provided by subject matter experts, using annotation/tagging data provided by named-entity-recognition-based heuristics, using annotation/tagging data provided by regular-expression-based heuristics, using annotation/tagging data provided by dictionary-mapping-based heuristics, and/or the like).

In some embodiments, the token-wise entity type classification machine learning model is configured to process an input table token sequence that is an ordered sequence of the table tokens of a table data object. In some embodiments, the input table token sequence of a table data object is generated based at least in part on a text sequence of a text data object that is associated with the table data object, such as a text sequence whose respective text ordering is generated based at least in part on at least one of relative cell position measures or optical character recognition output sequence orderings as described above. some embodiments, the input table token sequence of a table data object is generated based at least in part on a text sequence of a text data object that is associated with the table data object, such as a text sequence whose respective text ordering is generated based at least in part on at least one of relative cell position measures, relative token position measures, optical character recognition output sequence orderings, and/or the like. In some embodiments, the token-wise entity type classification machine learning model is configured to process an input table token sequence of the plurality of table tokens to generate, for each table token associated with the input table token sequence, the predicted entity types for the table token. In some embodiments, the input table token sequence is generated based at least in part on an optical character recognition output sequence of a text data object generated by performing one or more optical character recognition operations on an image data object associated with the table data object.

In some embodiments, the token-wise entity type classification machine learning model is configured to process the table tokens of a table data object in accordance with a cross-token attention-based mechanism to generate, for each table token, the predicted entity types for the table token. In some embodiments, the token-wise entity type classification machine learning model is configured to process the table tokens of a table data object along with positional embeddings for the table tokens and in accordance with a cross-token attention-based mechanism to generate, for each table token, the predicted entity types for the table token. In some embodiments, the positional embedding for a table token is generated based at least in part on the relative token position measure for the table token. In some embodiments, the positional embedding for a table token is generated based at least in part on the relative token position measure for the table token, the relative cell position measure for the boundary-separated cell that is associated with the table token, the position of the table token in a text ordering of a text data object associated with the corresponding table data object, and/or the like.

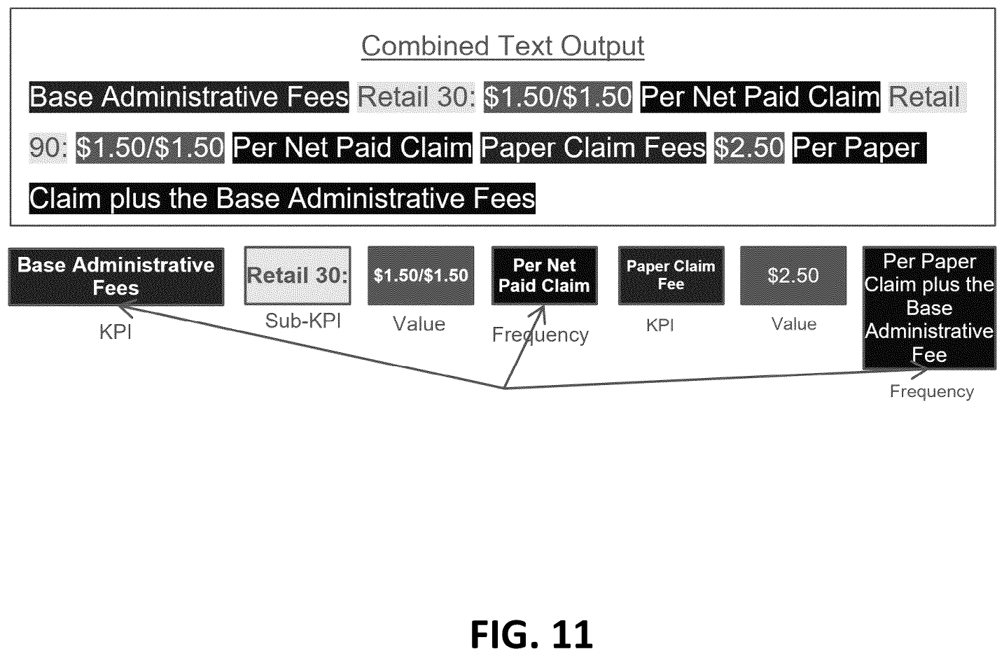

Operational examples of predicted entity types for a set of table tokens of the table data object 801 are depicted in FIG. 10. As depicted in FIG. 10, each table token (corresponding to a respective non-header row of the depicted table) is associated with a predicted table entity that is depicted by a corresponding value in the preds column of the depicted table. For example, table token “Term of contract:” is associated with the metrics/KPI entity type. Other operational examples of predicted entity types for table tokens are depicted in FIG. 8 and in the coloring schemes assigned to the table tokens in FIG. 11.

Returning to FIG. 4, at step/operation 404, the predictive data analysis computing entity 106 generates a graph-based table representation for the table data object. The graph-based table representation may describe a computer-readable graph structure in which table tokens of a corresponding table data object are nodes/vertices of the graph structure and in which relationships/edges exists between node pairs whose corresponding entity pairs are determined to be related based at least in part on at least some of the techniques described herein.

In some embodiments, a node N1 that is associated with a table token T1 having a defined entity type E1 is linked to a node N2 that is associated with a table token T2 having a defined entity type E2 in the graph-based table representation if: (i) E1 and E2 are determined to be potentially related (i.e., E1 is in the potentially-related defined entity type set for E2, E2 is in the potentially-related defined entity type set for E1, both E1 is in the potentially-related defined entity type set for E2 and E1 is in the potentially-related defined entity type set for E2, and/or the like), (ii) the relative token position measure for T1 and the relative token position measure for T2 satisfy one or more defined token proximity criteria. In some of the noted embodiments, if a corresponding inter-related entity type taxonomy defines that an E2-typed table token can relate to at most one E1-typed table token (e.g., which could happen if E1 is deemed to be a parent type of E2, for example if the root-KPI entity type is deemed to be a parent of the KIP entity type), then the defined token proximity criteria may include a criterion that is determined based at least in part on whether T1 is the E1-typed table token having the highest cross-token proximity score with respect to T2. In some, if a corresponding inter-related entity type taxonomy defines that an E1-typed table token can relate to more than one E2-typed table token (e.g., which could happen if E2 is deemed to be a child/grandchild/nth-degree-child type of E1, for example if the KIP entity type is deemed to be a child type of the root-KPI entity type), then the defined token proximity criteria may include a criterion that is determined based at least in part on whether the cross-token proximity score for T1 and T2 satisfies (e.g., exceeds) a cross-token proximity score threshold.

In some embodiments, the cross-token proximity score describes a measure of positional/organizational proximity of table portions associated with two table tokens within a corresponding table token. In some embodiments, the cross-token proximity score for a pair of table tokens is a weighted combination of a set of proximity indicators, such as a proximity indicator that is determined based at least in part on an inverse of a distance measure between relative token position measures for the pair, an inverse of a distance measure between relative centroid pixel values for the pair, a proximity indicator that has a value of one if the pair are in the same boundary-separated table cell, a proximity indicator that has a value of one if the pair are in the same boundary-separated table row, a proximity indicator that has a value of one if the pair are in the same boundary-separated table column, a proximity indicator that has a value of one if one table token in the pair is in a table header of a table portion that comprises a second table token in the table pair, and/or the like.

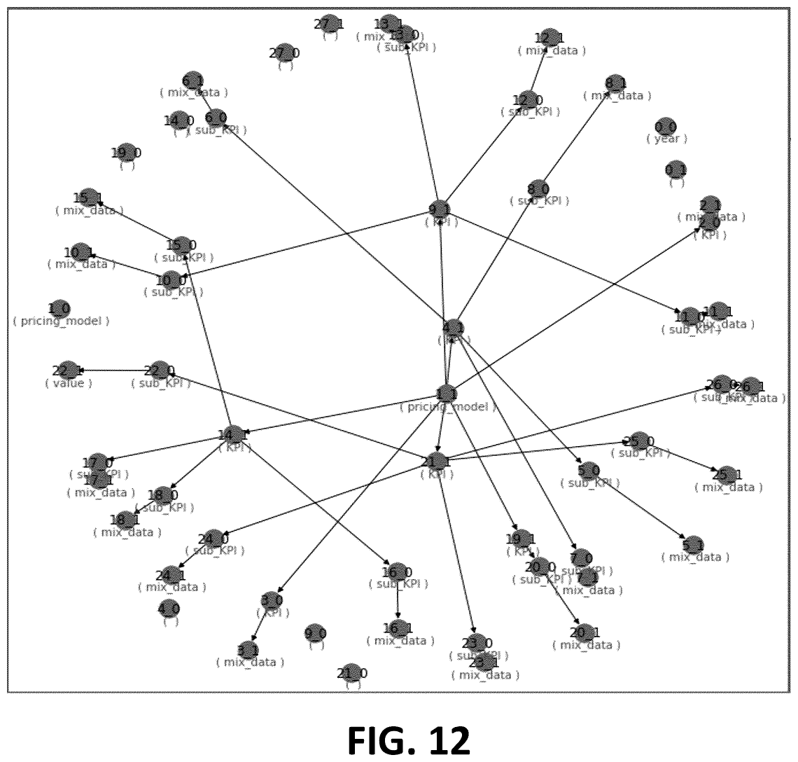

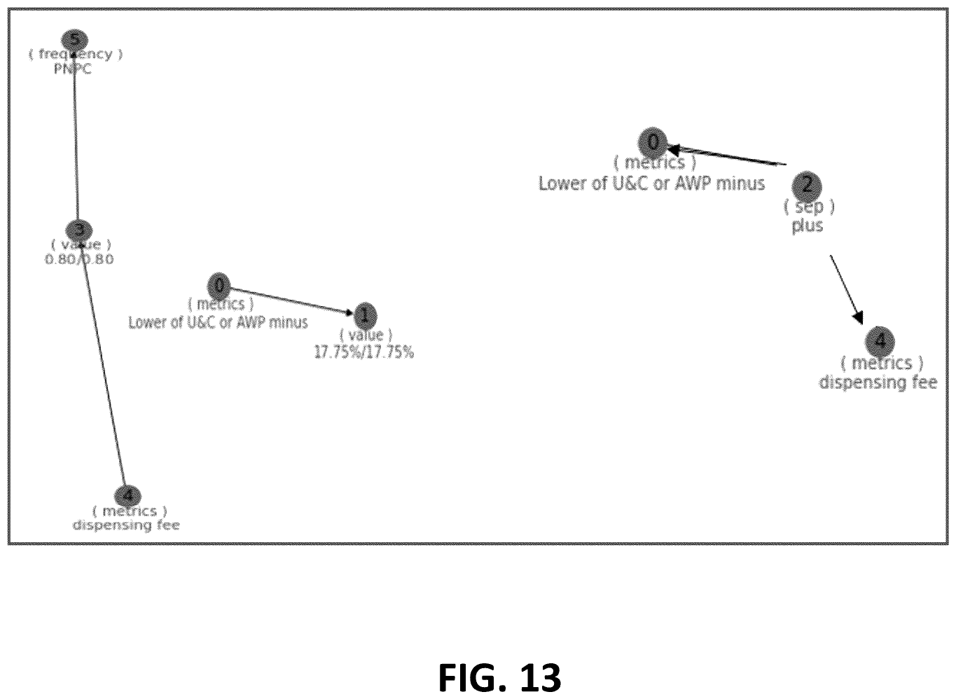

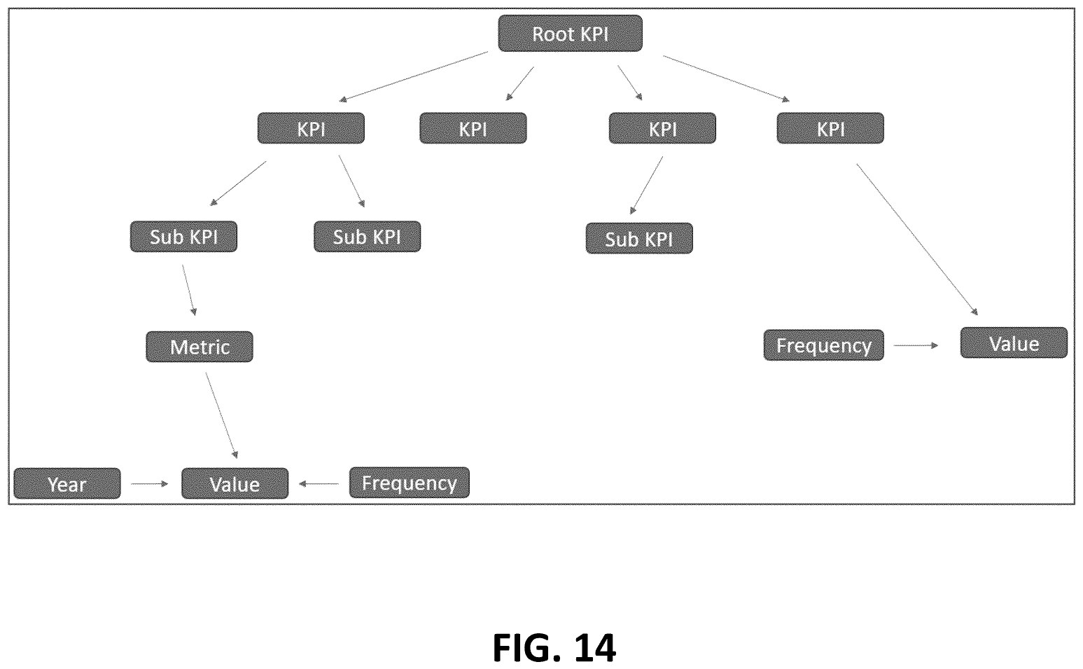

In some embodiments, the graph-based table representation includes a link/edge between two nodes associated with two table tokens if the predicted entity types of the two table tokens are determined to be related to one another. In some embodiments, a link/edge exists between two nodes associated with two table tokens if at least one of the two table tokens is in the related token set of the other table token in the pair. In some embodiments, each related table token in the related token set for a particular table token is associated with a corresponding defined entity type that is in the potentially related defined entity type set, and each related table token in the related token set for a particular table token is selected based at least in part on the relative token position measure for the particular table token and the relative token position measure for the related table token. Operational examples of graph-based table representations are depicted in FIGS. 12-13, while FIG. 14 depicts a set of defined cross-entity-type relationships between a set of defined entity type.

Returning to FIG. 4, at step/operation 405, the predictive data analysis computing entity 106 generates the semantic table representation for the table data object based at least in part on the graph-based table representation. In some embodiments, the predictive data analysis computing entity 106 generates the semantic table representation for the table data object by performing one or more defined-pattern graph traversal operations performed on the graph-based table representation. In some embodiments, the one or more defined-pattern graph traversal operations comprise one or more breadth first search graph traversal operations. In some embodiments, the one or more defined-pattern graph traversal operations comprise one or more depth first search graph traversal operations.

In some embodiments, a semantic table representation describes semantic relationships between table tokens/entities of a table based at least in part on expected potential relationships between those tokens/entities as determined based at least in part on predicted entity types of those tokens/entities. In some embodiments, a semantic table representation is generated using a token-wise entity type classification mechanism whose output space is defined by a set of defined entity types characterized by an inter-related entity type taxonomy to generate a representation of a table data object that describes per-token semantic inferences and cross-token semantic inferences performed on the table data object in accordance with subject-matter-domain insights as described by the inter-related entity type taxonomy.

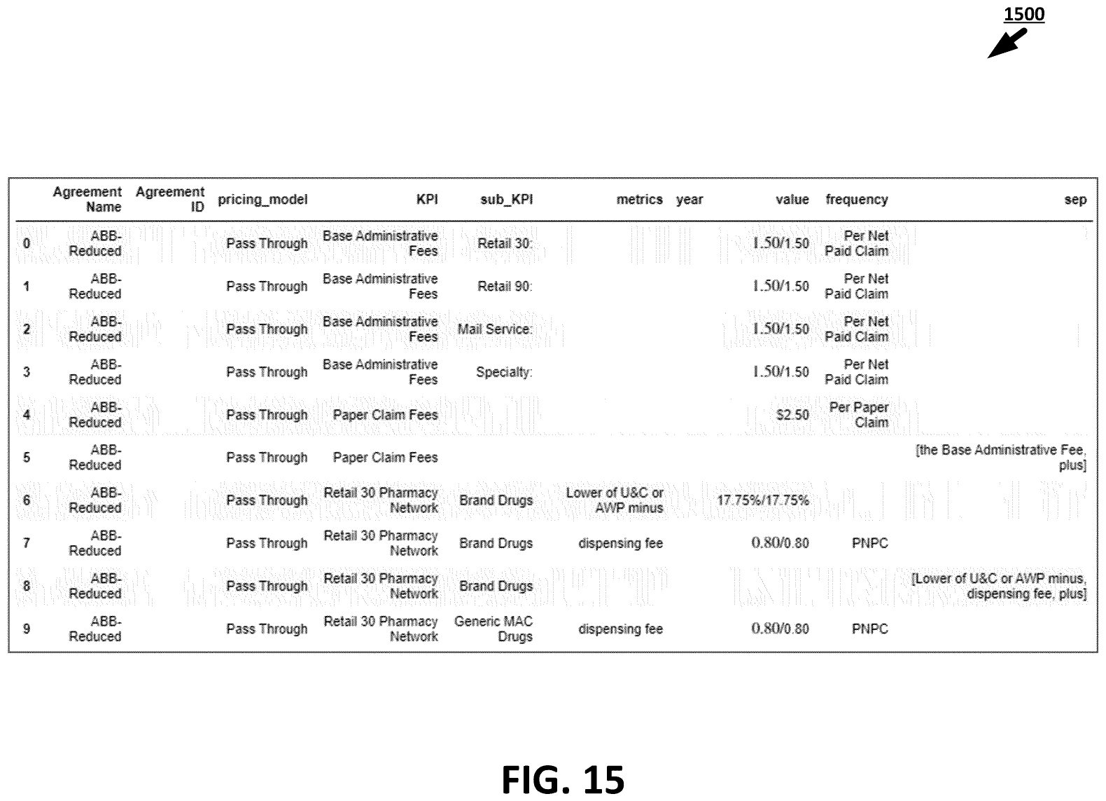

At step/operation 406, the predictive data analysis computing entity 106 performs one or more prediction-based actions based at least in part on the semantic table representation. An example of the prediction-based actions includes generating a semantically refined relational table data object that depicts extracted semantic relationships of table tokens of the table data object using a relational data model and generating display data for the semantically refined relational table data object, where the display data can be used to generate a prediction output user interface that can be used to display the semantically refined relational table data object. An operational example of such a prediction output user interface 1500 is depicted in FIG. 15.

Another operational example of prediction-based actions that may be performed in accordance with various embodiments of the present invention relates to performing operational load balancing operations for post-prediction systems by using semantic table representations to set the number of allowed computing entities used by the noted post-prediction systems. For example, in some embodiments, a predictive data analysis computing entity determines D table classifications for D table data objects based at least in part on the D semantic table representations for the D table data objects. Then, the count of table data objects that are associated with an affirmative table classification, along with a resource utilization ratio for each table data object, can be used to predict a predicted number of computing entities needed to perform post-prediction processing operations (e.g., automated investigation operations) with respect to the D table data objects. For example, in some embodiments, the number of computing entities needed to perform post-prediction processing operations (e.g., automated investigation operations) with respect to D table data objects can be determined based at least in part on the output of the equation: R=ceil(Σₖ^{k=K}urₖ), where R is the predicted number of computing entities needed to perform post-prediction processing operations with respect to the D table data object, ceil(·) is a ceiling function that returns the closest integer that is greater than or equal to the value provided as the input parameter of the ceiling function, k is an index variable that iterates over K table data objects among the D table data that are associated with affirmative classifications, and urₖ is the estimated resource utilization ratio for a kth table data object that may be determined based at least in part on a count of utterances/tokens/words in the kth table data object. In some embodiments, once R is generated, the predictive data analysis computing entity can use R to perform operational load balancing for a server system that is configured to perform post-prediction processing operations (e.g., automated investigation operations) with respect to D table data objects. This may be done by allocating computing entities to the post-prediction processing operations if the number of currently allocated computing entities is below R, and deallocating currently allocated computing entities if the number of currently allocated computing entities is above R.

Accordingly, as described above, various embodiments of the present invention make important technical contributions to improving predictive accuracy of natural language processing machine learning models, which in turn improves training speed and training efficiency of training natural language processing machine learning models. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures, see, e.g., Sun et al., Feature-Frequency—Adaptive On-line Training for Fast and Accurate Natural Language Processing in 40(3) Computational Linguistic 563 at Abst. (“Typically, we need to make a tradeoff between speed and accuracy. It is trivial to improve the training speed via sacrificing accuracy or to improve the accuracy via sacrificing speed. Nevertheless, it is nontrivial to improve the training speed and the accuracy at the same time”). Accordingly, techniques that improve predictive accuracy without harming training speed, such as the techniques described herein, enable improving training speed given a constant predictive accuracy. In doing so, the techniques described herein improving efficiency and speed of training natural language processing machine learning models, thus reducing the number of computational operations needed and/or the amount of training data entries needed to train natural language processing machine learning models. Accordingly, the techniques described herein improve at least one of the computational efficiency, storage-wise efficiency, and speed of training natural language processing machine learning models.

An exemplary application of various embodiments of the present invention relates to generating an optimal conceptual representation of a table by: (i) analyzing a sequence of table cell values for the table using named entity recognition to identify table entities, (ii) mapping the extracted entities using a graph-based technique that describes hierarchical relationships between the graph entities to generate a table graph, (iii) processing the resulting table graph using a breadth-first-search tree search technique to mine an optimal conceptual relationship set for each extracted entity, and (iv) generating an output representation table in which each row corresponds to the optimal conceptual relationship set for a corresponding table row.

Various embodiments of the present invention are configured to perform the following steps/operations: (i) a table image is converted to a set of table cells using optical character recognition, (ii) a sequence of table cells is analyzed using named entity recognition to identify table entities (e.g., events, sub-events, metrics, frequencies, and/or the like), (iii) extracted entities are embedded using a graph-based technique that maps hierarchical relationships between the graph entities; (iv) resulting graph is processed using a breadth-first search tree search technique to mine an optimal conceptual relationship set for each extracted entity; and (v) the optimal conceptual relationship set is used to construct an output representation table in which each row corresponds to the optimal conceptual relationship set for a corresponding table row.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a semantic table representation for a table data object using a token-wise entity type classification mechanism, the computer-implemented method comprising:
identifying, using one or more processors, a plurality of table tokens of the table data object, wherein each table token is associated with a relative token position measure within the table data object;
for each table token, using the one or more processors:
generating, using a token-wise entity type classification machine learning model, a predicted entity type, wherein: (i) the predicted entity type is selected from a plurality of defined entity types associated with an inter-related entity type taxonomy for the table data object, and (ii) the inter-related entity type taxonomy defines, for each defined entity type, a potentially related defined entity type set of the plurality of defined entity types, and
generating a related token set of the plurality of table tokens for the table token, wherein: (i) each related table token in the related token set is associated with a corresponding defined entity type that is in the potentially-related defined entity type set, and (ii) each related table token in the related token set is selected based at least in part on the relative token position measure for the table token and the relative token position measure for the related table token;
generating, using the one or more processors, and based at least in part on the plurality of table tokens and each related token set, a graph-based table representation for the table data object, wherein: (i) nodes of the graph-based table representation correspond to the plurality of table tokens, and (ii) links of the graph-based table representation correspond to cross-token relationships defined by each related token set;
generating, using the one or more processors and based at least in part on performing one or more defined-pattern graph traversal operations performed on the graph-based table representation, the semantic table representation; and
performing, using the one or more processors, one or more prediction-based actions based at least in part on the semantic table representation.

2. The computer-implemented method of claim 1, wherein generating the plurality of table tokens comprises performing one or more named entity recognition operations on a text data object associated with the table data object to generate the plurality of table tokens.

3. The computer-implemented method of claim 2, wherein the text data object is generated by performing one or more optical character recognition operations on an image data object associated with the table data object.

4. The computer-implemented method of claim 1, wherein the token-wise entity type classification machine learning model is configured to process an input table token sequence of the plurality of table tokens to generate, for each table token associated with the input table token sequence, the predicted entity types for the table token.

5. The computer-implemented method of claim 4, wherein the input table token sequence is generated based at least in part on an optical character recognition output sequence of a text data object generated by performing one or more optical character recognition operations on an image data object associated with the table data object.

6. The computer-implemented method of claim 1, wherein the one or more defined-pattern graph traversal operations comprise one or more breadth first search graph traversal operations.

7. The computer-implemented method of claim 1, wherein the one or more defined-pattern graph traversal operations comprise one or more depth first search graph traversal operations.

8. An apparatus for generating a semantic table representation for a table data object using a token-wise entity type classification mechanism, the apparatus comprising at least one processor and at least one memory including program code, the at least one memory and the program code configured to, with the processor, cause the apparatus to:
identify a plurality of table tokens of the table data object, wherein each table token is associated with a relative token position measure within the table data object;
for each table token:
generate, using a token-wise entity type classification machine learning model, a predicted entity type, wherein: (i) the predicted entity type is selected from a plurality of defined entity types associated with an inter-related entity type taxonomy for the table data object, and (ii) the inter-related entity type taxonomy defines, for each defined entity type, a potentially related defined entity type set of the plurality of defined entity types, and
generate a related token set of the plurality of table tokens for the table token, wherein: (i) each related table token in the related token set is associated with a corresponding defined entity type that is in the potentially-related defined entity type set, and (ii) each related table token in the related token set is selected based at least in part on the relative token position measure for the table token and the relative token position measure for the related table token;
generate, based at least in part on the plurality of table tokens and each related token set, a graph-based table representation for the table data object, wherein: (i) nodes of the graph-based table representation correspond to the plurality of table tokens, and (ii) links of the graph-based table representation correspond to cross-token relationships defined by each related token set;
generate, based at least in part on performing one or more defined-pattern graph traversal operations performed on the graph-based table representation, the semantic table representation; and
perform one or more prediction-based actions based at least in part on the semantic table representation.

9. The apparatus of claim 8, wherein generating the plurality of table tokens comprises performing one or more named entity recognition operations on a text data object associated with the table data object to generate the plurality of table tokens.

10. The apparatus of claim 9, wherein the text data object is generated by performing one or more optical character recognition operations on an image data object associated with the table data object.

11. The apparatus of claim 8, wherein the token-wise entity type classification machine learning model is configured to process an input table token sequence of the plurality of table tokens to generate, for each table token associated with the input table token sequence, the predicted entity types for the table token.

12. The apparatus of claim 11, wherein the input table token sequence is generated based at least in part on an optical character recognition output sequence of a text data object generated by performing one or more optical character recognition operations on an image data object associated with the table data object.

13. The apparatus of claim 8, wherein the one or more defined-pattern graph traversal operations comprise one or more breadth first search graph traversal operations.

14. The apparatus of claim 8, wherein the one or more defined-pattern graph traversal operations comprise one or more depth first search graph traversal operations.

15. A computer program product for generating a semantic table representation for a table data object using a token-wise entity type classification mechanism, the computer program product comprising at least one non-transitory computer-readable storage medium having computer-readable program code portions stored therein, the computer-readable program code portions configured to
identify a plurality of table tokens of the table data object, wherein each table token is associated with a relative token position measure within the table data object;
for each table token:
generate, using a token-wise entity type classification machine learning model, a predicted entity type, wherein: (i) the predicted entity type is selected from a plurality of defined entity types associated with an inter-related entity type taxonomy for the table data object, and (ii) the inter-related entity type taxonomy defines, for each defined entity type, a potentially related defined entity type set of the plurality of defined entity types, and
generate a related token set of the plurality of table tokens for the table token, wherein: (i) each related table token in the related token set is associated with a corresponding defined entity type that is in the potentially-related defined entity type set, and (ii) each related table token in the related token set is selected based at least in part on the relative token position measure for the table token and the relative token position measure for the related table token;
generate, based at least in part on the plurality of table tokens and each related token set, a graph-based table representation for the table data object, wherein: (i) nodes of the graph-based table representation correspond to the plurality of table tokens, and (ii) links of the graph-based table representation correspond to cross-token relationships defined by each related token set;
generate, based at least in part on performing one or more defined-pattern graph traversal operations performed on the graph-based table representation, the semantic table representation; and
perform one or more prediction-based actions based at least in part on the semantic table representation.

16. The computer program product of claim 15, wherein generating the plurality of table tokens comprises performing one or more named entity recognition operations on a text data object associated with the table data object to generate the plurality of table tokens.

17. The computer program product of claim 16, wherein the text data object is generated by performing one or more optical character recognition operations on an image data object associated with the table data object.

18. The computer program product of claim 15, wherein the token-wise entity type classification machine learning model is configured to process an input table token sequence of the plurality of table tokens to generate, for each table token associated with the input table token sequence, the predicted entity types for the table token.

19. The computer program product of claim 18, wherein the input table token sequence is generated based at least in part on an optical character recognition output sequence of a text data object generated by performing one or more optical character recognition operations on an image data object associated with the table data object.

20. The computer program product of claim 15, wherein the one or more defined-pattern graph traversal operations comprise one or more breadth first search graph traversal operations.
